(19) United States
(12) Patent Application Publication
(10) Pub. No.: US 2021/0241270 A1
(43) Pub. Date: Aug. 5, 2021

(54) SYSTEM AND METHOD OF BLOCKCHAIN TRANSACTION VERIFICATION

(71) Applicant: Acronis International GmbH, Schaffhausen (CH)

(72) Inventors: Alexey Raevsky, Moscow (RU); Max Lyadvinsky, Moscow (RU)

(21) Appl. No.: 17/237,198

(22) Filed: Apr. 22, 2021

Related U.S. Application Data
(63) Continuation of application No. 15/856,917, filed on Dec. 28, 2017.

(51) Int. Cl. G06Q 20/38; G06Q 20/40; G06Q 20/32

(52) U.S. Cl. CPC G06Q 20/3829; G06Q 20/385; G06Q 2220/00; G06Q 20/3255; G06Q 20/4014

(57) ABSTRACT

Disclosed are systems and methods for verifying a blockchain transaction using multiple digital signatures. A method comprises generating, by a user device, a data structure associated with a first user account from which assets are drawn and output to a second user account. The method comprises generating, by the user device, a first digital signature based on the data structure using a first private encryption key stored at the user device, and transmitting, by the user device, a verification indication comprised of a one-time password to a service provider. In response to transmitting the verification indication, the method comprises receiving a second digital signature generated by the service provider based on the data structure using a second private encryption key. The method comprises transmitting, by the user device to a blockchain network for verification, the data structure that includes the first digital signature and the second digital signature.

### CROSS-REFERENCE TO RELATED APPLICATIONS

This application is a continuation of U.S. Non-Provisional application Ser. No. 15/856,917, which is herein incorporated by reference.

### FIELD OF TECHNOLOGY

The present disclosure relates generally to the field of cryptocurrencies and blockchain-based transactions, more specifically, to systems and methods of verifying a blockchain transaction using multiple digital signatures.

### BACKGROUND

Cryptocurrency refers to a digital asset that uses cryptography to secure its assets, control the creation of additional assets (i.e., “mining”), and verify the transfer of asserts. Blockchain technology is an emerging technology that has been used in cryptocurrency implementations. The blockchain is a data structure that stores a list of transactions and can be thought of as a distributed electronic ledger that records transactions between a source and a destination. The transactions are batched together into blocks and every block refers back to or is linked to a prior block in the chain. Computer nodes, sometimes referred to as miners, maintain the blockchain and cryptographically validate each new block (and the transactions contained therein) using a proof-of-work system.

One drawback to cryptocurrencies is the problem of unauthorized use of private encryption keys by a service provider. Cryptocurrency service providers, such as cryptocurrency exchanges, online wallet providers, etc., hold private keys of their customers and signs transactions for the blockchain on their behalf. However, such approaches may result in serious financial risk in cases of authentication breaches (e.g., when a malicious user succeeds in impersonating as an authorized user) or in cases of intentional or negligent misuse of clients' encryption keys (e.g., embezzlement, poor security practices by the service provider).

### SUMMARY

Thus, a system and method is disclosed herein for managing blockchain-based transactions, and, more particularly, for verifying a blockchain transaction using multiple digital signatures. In one aspect, a multi-signature “wallet” is used, where one private key is stored by a service provider and another key is stored by the customer. To execute a transaction, the customer creates a transaction and signs it with their private key. The customer may then log into the service provider and request for signature of this transaction. The service provider may send to the customer a one-time password (for example, via SMS text message), and the customer enters this one-time password to confirm their identity. If successful, the service provider signs the transaction using its private key, and the transaction is sent to the blockchain network.

A computer-implemented method for executing a blockchain-based transaction is provided. The method includes generating a transaction data structure, wherein the transaction data structure is associated with a first user account and indicates output to a second user account and generating, by the user device, a first digital signature based on the transaction data structure using a first private key stored at the user device. The method further includes establishing a communication session with a transaction service of a service provider using user credentials associated with the first user account, and transmitting, to the service provider, a signing request associated with the transaction data structure and a verification indication that causes the service provider to generate a second digital signature based on the transaction data structure using a second private key that is stored at the service provider. The method includes transmitting the transaction data structure that includes the first digital signature and the second digital signature to a blockchain network for verification.

In another aspect, the method further includes receiving, by the user device, a one-time password in response to the signing request, wherein the verification indication transmitted to the service provider includes the one-time password.

In another aspect, the one-time password is received by the user device as a text message via a short message service (SMS).

In another aspect, the one-time password is generated by the user device using a keyed-hash message authentication code (HMAC)-based or time-based password generator associated with the first user account.

In another aspect, the method further includes determining whether the second user account is contained in a list of known accounts, and responsive to determining that the second user account is not contained in the list of known accounts, initiating a know-your-customer (KYC) procedure for the second user account. The method may include, responsive to determining that the second user account is contained in the list of known accounts, completing the signing request by generating the second digital signature for the transaction data structure.

In another aspect, the method further includes, responsive to determining that the KYC procedure for the second user account was unsuccessful, cancelling the signing request associated with the transaction data structure. The method further includes, responsive to determining that the KYC procedure for the second user account was successful, completing the signing request by generating the second digital signature for the transaction data structure.

According to another aspect, a system for executing a blockchain-based transaction is provided. The system includes a memory device configured to store a first private key associated with a first user account, and a processor. The processor may be configured to generate a transaction data structure, wherein the transaction data structure is associated with the first user account and indicates output to a second user account, and generate a first digital signature based on the transaction data structure using the first private key. The processor may be further configured to establish a communication session with a transaction service of a service provider using user credentials associated with the first user account, transmit, to the service provider, a signing request associated with the transaction data structure and a verification indication that causes the service provider to generate a second digital signature based on the transaction data structure using a second private key that is stored at the service provider, and transmit the transaction data structure that includes the first digital signature and the second digital signature to a blockchain network for verification.

According to another aspect, a system for executing a blockchain-based transaction is provided. The system may include a user device having a memory device configured to store a first private key associated with a first user account, and a processor. The system may include a server system having a memory device configured to store a second private key, and a processor. The processor of the user device is configured to generate a transaction data structure, wherein the transaction data structure is associated with the first user account and indicates output to a second user account, generate a first digital signature based on the transaction data structure using the first private key, establish a communication session with a transaction service of the server system using user credentials associated with the first user account, and transmit, to the server system, a signing request associated with the transaction data structure and a verification indication. The processor of the server system is configured to generate a second digital signature based on the transaction data structure using the second private key in response to the verification indication from the user device. The processor of the user device is further configured to transmit the transaction data structure that includes the first digital signature and the second digital signature to a blockchain network for verification.

According to another exemplary aspect, a computer-readable medium is provided comprising instructions that comprises computer executable instructions for performing any of the methods disclosed herein.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for executing a blockchain-based transaction, according to an exemplary aspect.

FIG. 2 is a block diagram illustrating a workflow of graphical user interfaces for executing a blockchain-based transaction, according to an exemplary aspect.

FIG. 3 is a flowchart illustrating a method for executing a blockchain-based transaction according to an exemplary aspect.

FIG. 4 is a block diagram of a general-purpose computer system on which the disclosed system and method can be implemented according to an exemplary aspect.

### DETAILED DESCRIPTION

Exemplary aspects are described herein in the context of a system, method, and computer program product for executing a blockchain-based transaction. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

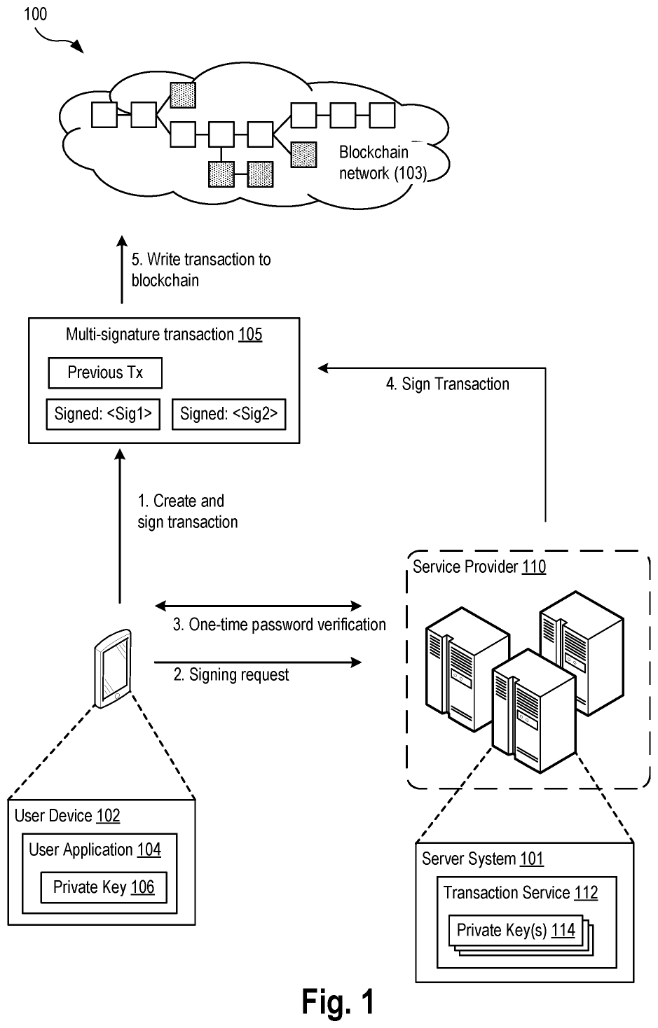

FIG. 1 is a block diagram illustrating a system 100 for executing a blockchain-based transaction, according to an exemplary aspect. The system 100 may include a user device 102, one or more server systems 101 associated with a service provider 110, and a blockchain network 103. The user device 102 may be one of personal computers, servers, laptops, tables, mobile devices, smart phones, cellular devices, portable gaming devices, media players or any other suitable devices that can retain, manipulate and transfer data. The user device 102 may include a user application 104 configured to perform one or more cryptocurrency or blockchain-based transactions with the blockchain network 103 in coordination with a transaction service 112 executing in the server system 101.

According to an exemplary aspect, the blockchain network 103 can be an existing (public or private) distributed network formed from a plurality of peer-to-peer nodes or computers. According to aspects, the blockchain network 103 maintains a continuously-growing list of data records hardened against tampering and revision and is composed of data structure blocks that hold the data received from other nodes or client nodes, including the user device 102 and server systems 101. The user device 102 may transmit data values to the blockchain network 103 as a transaction data structure, and the transaction in the blockchain records blocks and confirms when and in what sequence the data transactions enter and are logged in the existing blockchain. Every node in the decentralized system can have a copy of the growing blockchain, avoiding the need to have a centralized ledger managed by a trusted third party. Moreover, each of the nodes can validate the data, add hash values to their copy of the blockchain, and then broadcast these additions to other nodes in accordance with existing blockchain methodologies.

A “wallet” as used herein may refer to a user account provided by a service provider 110 that enables access to electronic currency, cryptocurrency, or other assets associated with the user account for use in transactions and other operations. In prior approaches, a single private encryption key can define a cryptocurrency wallet. That is, the holder of the private key is able to sign transactions to spend cryptocurrency from the wallet. The transaction is then put into force by being recorded in the blockchain network 103.

According to an aspect, rather than use a single-signature “wallet”, the user application 104 and the transaction service 112 may be configured to use a multi-signature wallet, where one private encryption key 114 is stored by the service provider 110, and another private encryption key 106 is stored by the customer (e.g., at the user device 102). The service provider 110 may be configured to store separate private keys 114 for each customer of the service 112. A pair of customer-owned and service-provider-owned private encryption keys 106, 114 may constitute a multi-signature wallet.

According to one aspect, the user application 104 may be configured to (e.g., in response to user input) generate a transaction data structure 105 associated with a first user account and indicating output to a second user account. In some aspects, the transaction data structure 105 may indicate one or more amounts of assets (e.g., 0.05 Bitcoin, or BTC) that represent the output of the transaction data structure 105. The transaction data transaction 105 may include a reference to a prior transaction data structure. For example, in the case of a cryptocurrency transaction, the reference to a prior transaction data structure may be the transaction identifier of the prior cryptocurrency transaction from which the assets of the current transaction are drawn (e.g., Input). In some aspects, the transaction identifier may simply be a hash value of the data values in a single transaction data structure (e.g. in a serialized binary form).

In one aspect, the user application 104 may be configured to generate a first digital signature based on the transaction data structure using a first private key 106 associated with the first user account and stored at the user device 102. In some aspects, the digital signature may be an encryption of the transaction hash calculate using the private key 106. In some aspects, digital signatures may be generated based on elliptic curve cryptography, such as the Elliptic Curve Digital Signature Algorithm (ECDSA), or other forms of cryptographic algorithms such as the Digital Signature Algorithm (DSA).

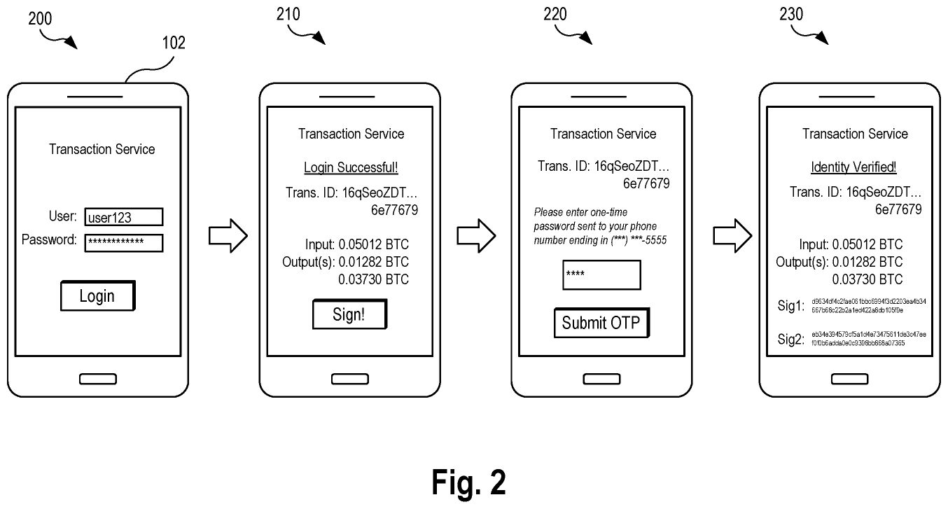

To provide the other signature needed for the multi-signature wallet, the user application 104 may establish a communication session with a transaction service 112 of the service provider 110 using user credentials associated with the first user account. In some aspects, the user application 104 may provide a log-in screen to a user of the user device, which is configured to receive credentials, such as a username and password, and logs into the service provider 110. In other aspects, the user application 104 may direct the user to a web browser (not shown) executing on the user device 102 to access a web site or web application provided by the transaction service 112. In other aspects, the user application 104 may direct the user to another application installed on the user device 102 that is provided by the transaction service 112 for authentication purposes. An example graphical user interface 200 of the user device 102 for establishing a communication session with a transaction service 112 of the service provider 110 is shown in FIG. 2.

In one aspect, the user application 104 may transmit, to the service provider 110, a signing request associated with the transaction data structure 105 and a verification indication that causes, in all, the service provider 110 to generate a second digital signature based on the transaction data structure using a second private key 114. The second private key 114 may be stored at the service provider 110 and is associated with the first user account.

For example, the user may successfully log into the service provider 110 and request the service provider 110 sign this transaction (i.e., transmit a signing request associated with the transaction data structure 105). In response, the transaction service 112 may generate and transmit, to the user device 102, a one-time password associated with the signing request of the transaction data structure 105. In some aspects, the one-time password is transmitted as a text message via a short message service (SMS) to a telephone number associated with the user account (e.g., the telephone number of the user device 102 in aspects where the user device is a smartphone). In some aspects, the one-time password may be generated by the user device using a keyed-hash message authentication code (HMAC)-based or time-based password generator associated with the first user account. In some aspects, the one-time password may be time-restricted, i.e., valid for a limited period of time. An example graphical user interface 210 for transmitting a signing request (e.g., “Sign!” button) is shown in FIG. 2.

The user device 102 receives the one-time password, and the user may enter the one-time password to confirm their identity and authorize the multi-signature transaction. In some aspects, the user may enter the one-time password within the communication session established between the transaction service 112 and the user device 102. For example, in an example graphical user interface 220 of the user device 102 shown in FIG. 2, the user may submit the one-time password in a user input field using the connected session with the transaction service 112. As such, the user application 104 may further transmit a verification indication includes the one-time password to cause the service provider 110 to generate a second digital signature based on the transaction data structure using the second private key 114. Other forms of verification indication may be used including using a dedicated application executing on the user device 102 for authenticating user identity.

In one aspect, the transaction service 112 may be configured to generate a second digital signature based on the transaction data structure 105 using the second private key 114 that is stored at the service provider 110 and is associated with the first user account. Similar to the first digital signature, the second digital signature may be generated based on elliptic curve cryptography, such as the Elliptic Curve Digital Signature Algorithm (ECDSA), or other forms of cryptographic algorithms such as the Digital Signature Algorithm (DSA). Accordingly, rather than using use a form of secret sharing, such as using Shamir's secret sharing scheme, that distributes parts of a divided key to different entities, aspects of the present disclosure provide two separate private keys created for a wallet (e.g., 2-of-2 MULTI-SIG) and that are both required for signing the transaction.

In one aspect, after the transaction is signed using both private keys, the user application 104 may be configured to transmit the transaction data structure 105 to the blockchain network 103. As shown in FIG. 1, the transaction data structure 105 may include both the first digital signature (e.g., “Signed: <Sig1>”) and the second digital signature (e.g., “Signed: <Sig2>”). As described earlier, the transaction data structure 105 may be recorded into the growing distributed ledger in the blockchain network 103.

It is understood that aspects of the present disclosure may be extended by omitting or re-arranging certain steps of the described workflow, or inserting other steps there between. For example, according to some aspects, the verification process may be omitted if a user has pre- determined (e.g., via user configuration or opt-out) not to use the verification indication. In such aspects, the transaction service 112 may be configured to sign the transaction data structure based on a successful authentication (e.g., establishment of the communication session.) In another aspects, a variant of the described method may be as follows. The user application (e.g., in response to user input) first establishes a communication session with the transaction service 112 and requests for a digital signature of a to-be-created transaction. Then, the transaction service 112 transmits to the user application a (SMS) verification request with a one-time password. The user enters the one-time password to confirm their identity. Then, the transaction service 112 generates and signs a transaction data structure 105 with its private key 114, the transaction service 112 is the entity first creating the data structure). The user application signs the transaction data structure 105 with the private key 106, and transmits the transaction data structure to the blockchain network 103.

According to another aspect of the present disclosure, the transaction service 112 may be configured to execute know-your-customer (KYC) procedure for user accounts that are the subjects of one or more transactions. A KYC procedure may include the identification and verification of the identity of a client, in this case, a second user account which is the other party listed on the transaction data structure 105.

In one aspect, the user may create a transaction and sign it with their private key 106. The user may then log into the service provider 110 and request for a digital signature of this transaction. Optionally, the service provider 110 may send to the customer a (SMS) verification with a one-time password; in which case, the user may enter the one-time password to confirm their identity and authorization to perform the requested transaction.

The transaction service 112 may be configured to check if the other party of the transaction data structure 105 is known. For example, the transaction service 112 may compare a user account identifier of the second user account to a list of previously known user accounts that have been transacted with. The list of previously known user accounts may be locally determined by the transaction service 112, or in other aspects, retrieved from a centralized list from third-party source. In another example, the transaction service 112 may check a hash address associated with the second user account to a list of previously flagged transaction.

If the other party is not known, the transaction service 112 may initiate a KYC procedure for the other party. In one aspect, the KYC procedure may include the collection and analysis of identity information related to the second user account (i.e., Customer Identification Program or CIP), name matching the second user account against lists of known parties (e.g., “politically exposed persons”), calculating a risk or behavior profile based on the second user account's transactional behavior, and monitoring the second user account's transactions against expected behavior and recorded behavior, or one or more of the above-described processes. If the KYC procedure is unsuccessful, the transaction may be canceled. Otherwise, if the other party is known or the KYC procedure is successful, then the service provider 110 may sign the transaction with its private key 114 and sends the transactions on to the blockchain network 103.

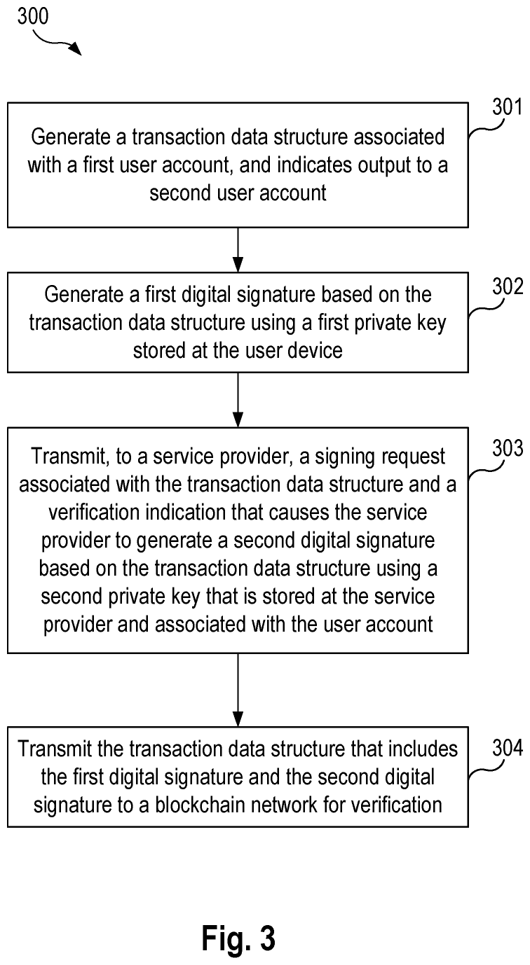

FIG. 3 is a flowchart illustrating a method 300 for executing a blockchain-based transaction according to an exemplary aspect. It is noted that the following description of the exemplary method makes reference to the system and components described above.

The method 300 begins at step 301, in which the user application 104 may generate (e.g., by a user device 102) a transaction data structure 105 having a reference to a prior transaction data structure, wherein the transaction data structure is associated with a first user account and indicates output to a second user account. At step 302, the user application 104 may generate (e.g., by the user device 102) a first digital signature based on the transaction data structure using a first private key 106 stored at the user device 102. At step 303, the user application 104 may establish a communication session with a transaction service 112 of the service provider 110 using user credentials associated with the first user account.

At step 304, the user application 104 may transmit, to a service provider 110, a signing request associated with the transaction data structure 105 and a verification indication that causes the service provider 110 to generate a second digital signature based on the transaction data structure 105 using a second private key 114 that is stored at the service provider and associated with the first user account. In some aspects, the user device 102 may receive a one-time password in response to the signing request, wherein the verification indication transmitted to the service provider includes the one-time password. In some aspects, the one-time password is received by the user device as a text message via a short message service (SMS). In some aspects, the one-time password is generated by the user device using a keyed-hash message authentication code (HMAC)-based or time-based password generator associated with the first user account.

In some aspects, the service provider 110 may determine whether the second user account is contained in a list of known accounts. Responsive to determining that the second user account is not contained in the list of known accounts, the service provider 110 may initiate a know-your-customer (KYC) procedure for the second user account. Responsive to determining that the second user account is contained in the list of known accounts, the service provider 110 may complete the signing request by generating the second digital signature for the transaction data structure. In some aspects, responsive to determining that the KYC procedure for the second user account was unsuccessful, the service provider 110 may cancel the signing request associated with the transaction data structure. In other aspects, responsive to determining that the KYC procedure for the second user account was successful, the service provider 110 may complete the signing request by generating the second digital signature for the transaction data structure.

At step 305, the user application 104 may transmit the transaction data structure 105 that includes the first digital signature and the second digital signature to a blockchain network 103 for verification.

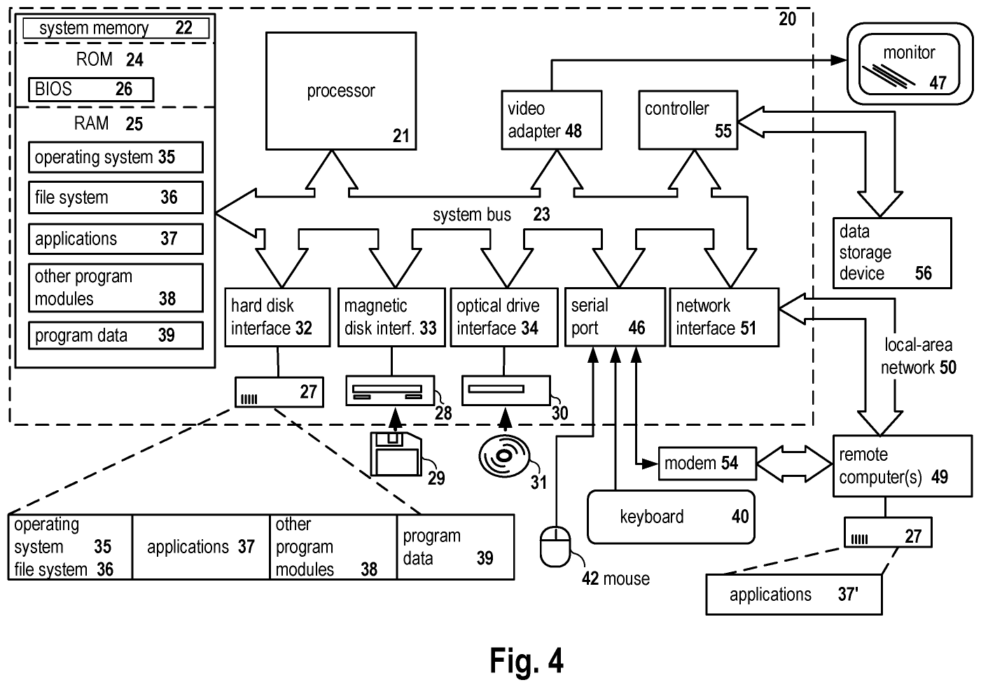

FIG. 4 is a block diagram illustrating a general-purpose computer system 20 on which aspects of systems and methods for executing a blockchain-based transaction may be implemented in accordance with an exemplary aspect. It should be noted that the computer system 20 can correspond to the user device 102, server systems 101, for example, described earlier.

As shown, the computer system 20 (which may be a personal computer or a server) includes a central processing unit 21, a system memory 22, and a system bus 23 connecting the various system components, including the memory associated with the central processing unit 21. As will be appreciated by those of ordinary skill in the art, the system bus 23 may comprise a bus memory or bus memory controller, a peripheral bus, and a local bus that is able to interact with any other bus architecture. The system memory may include permanent memory (ROM) 24 and random-access memory (RAM) 25. The basic input/output system (BIOS) 26 may store the basic procedures for transfer of information between elements of the computer system 20, such as those at the time of loading the operating system with the use of the ROM 24.

The computer system 20, may also comprise a hard disk 27 for reading and writing data, a magnetic disk drive 28 for reading and writing on removable magnetic disks 29, and an optical drive 30 for reading and writing removable optical disks 31, such as CD-ROM, DVD-ROM and other optical media. The hard disk 27, the magnetic disk drive 28, and the optical drive 30 are connected to the system bus 23 across the hard disk interface 32, the magnetic disk interface 33 and the optical drive interface 34, respectively. The drives and the corresponding computer information media are power-independent modules for storage of computer instructions, data structures, program modules and other data of the computer system 20.

An exemplary aspect comprises a system that uses a hard disk 27, a removable magnetic disk 29 and a removable optical disk 31 connected to the system bus 23 via the controller 55. It will be understood by those of ordinary skill in the art that any type of media 56 that is able to store data in a form readable by a computer (solid state drives, flash memory cards, digital disks, random-access memory (RAM) and so on) may also be utilized.

The computer system 20 has a file system 36, in which the operating system 35, may be stored, as well as additional program applications 37, other program modules 38, and program data 39. A user of the computer system 20 may enter commands and information using keyboard 40, mouse 42, or any other input device known to those of ordinary skill in the art, such as, but not limited to, a microphone, joystick, game controller, scanner, etc. Such input devices typically plug into the computer system 20 through a serial port 46, which in turn is connected to the system bus, but those of ordinary skill in the art will appreciate that input devices may be also be connected in other ways, such as, without limitation, via a parallel port, a game port, or a universal serial bus (USB). A monitor 47 or other type of display device may also be connected to the system bus 23 across an interface, such as a video adapter 48. In addition to the monitor 47, the personal computer may be equipped with other peripheral output devices (not shown), such as loudspeakers, a printer, etc.

Computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes.

Network connections can form a local-area computer network (LAN) 50 and a wide-area computer network (WAN). Such networks are used in corporate computer networks and internal company networks, and they generally have access to the Internet. In LAN or WAN networks, the personal computer 20 is connected to the local-area network 50 across a network adapter or network interface 51. When networks are used, the computer system 20 may employ a modem 54 or other modules well known to those of ordinary skill in the art that enable communications with a wide-area computer network such as the Internet. The modem 54, which may be an internal or external device, may be connected to the system bus 23 by a serial port 46. It will be appreciated by those of ordinary skill in the art that said network connections are non-limiting examples of numerous well-understood ways of establishing a connection by one computer to another using communication modules.

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In various aspects, the systems and methods described in the present disclosure can be addressed in terms of modules. The term “module” as used herein refers to a real-world device, component, or arrangement of components implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a general purpose computer (such as the one described in greater detail in FIG. 4, above). Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A method for verifying a blockchain transaction using multiple digital signatures, the method comprising:
generating, by a user device, a data structure associated with a first user account, wherein the data structure includes a reference to a prior data structure from which one or more assets associated with the first user account are drawn and indicates output of the one or more assets associated with the first user account to a second user account;
generating, by the user device, a first digital signature based on the data structure using a first private encryption key stored at the user device;
establishing, by the user device, a communication session with a service provider using user credentials associated with the first user account;
transmitting, to the service provider, a signing request associated with the data structure and receiving, by the user device, a one-time password in response to the signing request;
transmitting, by the user device, a verification indication comprised of the one-time password and in response to transmitting the verification indication, receiving a second digital signature generated by the service provider based on the data structure using a second private encryption key that is stored at the service provider; and
transmitting, by the user device to a blockchain network for verification, the data structure that includes the first digital signature and the second digital signature, wherein the first user account comprises a multi-signature wallet associated with the first private encryption key stored at the user device and the second private encryption key stored at the service provider.

2. The method of claim 1, wherein the one-time password is received by the user device as a text message via a short message service (SMS).

3. The method of claim 1, wherein the one-time password is generated by the user device using an encryption keyed-hash message authentication code (HMAC)-based password generator associated with the first user account.

4. The method of claim 1, wherein the one-time password expires after a threshold period of time.

5. The method of claim 1, further comprising:
determining whether the second user account is contained in a list of known accounts;
responsive to determining that the second user account is not contained in the list of known accounts, initiating a KYC procedure for the second user account; and
responsive to determining that the second user account is contained in the list of known accounts, completing the signing request by generating the second digital signature for the data structure.

6. The method of claim 5, further comprising:
responsive to determining that the KYC procedure for the second user account was unsuccessful, cancelling the signing request associated with the data structure; and
responsive to determining that the KYC procedure for the second user account was successful, completing the signing request by generating the second digital signature for the data structure.

7. The method of claim 1, wherein the first digital signature and/or the second digital signature are generated based on elliptic curve cryptography.

8. A system for verifying a blockchain transaction using multiple digital signatures, comprising:
a memory device configured to store a first private encryption key associated with a first user account; and
a processor configured to:
generate a data structure associated with the first user account, wherein the data structure includes a reference to a prior data structure from which one or more assets associated with the first user account are drawn and indicates output of the one or more assets associated with the first user account to a second user account;
generate a first digital signature based on the data structure using a first private encryption key;
establish a communication session with a service provider using user credentials associated with the first user account;
transmit, to the service provider, a signing request associated with the data structure and receiving a one-time password in response to the signing request;
transmit a verification indication comprised of the one-time password and in response to transmitting the verification indication, receiving a second digital signature generated by the service provider based on the data structure using a second private encryption key that is stored at the service provider;
transmit, to a blockchain network for verification, the data structure that includes the first digital signature and the second digital signature, wherein the first user account comprises a multi-signature wallet associated with the first private encryption key and the second private encryption key stored at the service provider.

9. The system of claim 8, wherein the processor is further configured to:
receive a one-time password in response to the signing request, wherein the verification indication transmitted to the service provider includes the one-time password.

10. The system of claim 8, wherein the one-time password is received as a text message via a short message service (SMS).

11. The system of claim 8, wherein the one-time password is generated using a keyed-hash message authentication code (HMAC)-based or time-based password generator associated with the first user account.

12. The system of claim 8, wherein the one-time password expires after a threshold period of time.

13. The system of claim 8, wherein the service provider is configured to:
determine whether the second user account is contained in a list of known accounts;
responsive to determining that the second user account is not contained in the list of known accounts, initiate a know-your-customer (KYC) procedure for the second user account; and
responsive to determining that the second user account is contained in the list of known accounts, complete the signing request by generating the second digital signature for the transaction data structure.

14. The system of claim 13, wherein the service provider is further configured to:
responsive to determining that the KYC procedure for the second user account was unsuccessful, cancel the signing request associated with the transaction data structure; and
responsive to determining that the KYC procedure for the second user account was successful, complete the signing request by generating the second digital signature for the transaction data structure.

15. The system of claim 8, wherein the first digital signature and/or the second digital signature are generated based on elliptic curve cryptography.

16. A system for executing verifying a blockchain transaction using multiple digital signatures, comprising:
a user device having a memory device configured to store a first private encryption key associated with a first user account, and a processor; and
a server system having a memory device configured to store a second private encryption key, and a processor;
wherein the processor of the user device is configured to:
generate a data structure, wherein the data structure is associated with the first user account and indicates output to a second user account,
generate a first digital signature based on the data structure using the first private encryption key,
establish a communication session with the server system using user credentials associated with the first user account, and
transmit, to the server system, a signing request associated with the data structure and a verification indication; and
wherein the processor of the server system is configured to generate a second digital signature based on the data structure using the second private encryption key in response to the verification indication from the user device;
wherein the processor of the user device is further configured to transmit the data structure that includes the first digital signature and the second digital signature to a blockchain network for verification.

17. The system of claim 16, wherein the processor of the user device is further configured to:
receive a one-time password in response to the signing request, wherein the verification indication transmitted to the server system includes the one-time password.

18. The system of claim 17, wherein the one-time password is received by the user device as a text message via a short message service (SMS).

19. The system of claim 17, wherein the one-time password is generated by the user device using a keyed-hash message authentication code (HMAC)-based or time-based password generator associated with the first user account.

20. The system of claim 16, wherein the processor of the server system is further configured to:
determine whether the second user account is contained in a list of known accounts;
responsive to determining that the second user account is not contained in the list of known accounts, initiate a know-your-customer (KYC) procedure for the second user account; and
responsive to determining that the second user account is contained in the list of known accounts, complete the signing request by generating the second digital signature for the transaction data structure.
